(19) United States
(12) Patent Application Publication
(10) Pub. No.: US 2024/0065294 A1
(43) Pub. Date: Feb. 29, 2024

(54) Composition for Using Brewery Wastes and Method of Preparing the Composition

(71) Applicant: Wilbur-Ellis Nutrition, San Francisco, CA (US)

(72) Inventor: Chad Desserich, Windsor, CO (US)

(73) Assignee: Wilbur-Ellis Nutrition, San Francisco, CA (US)

(21) Appl. No.: 18/205,989

(22) Filed: Jun. 5, 2023

Related U.S. Application Data
(60) Provisional application No. 63/354,131, filed on Jun. 21, 2022.

(51) Int. Cl. A23K 10/38; A23K 20/105

(52) U.S. Cl. CPC A23K 10/38; A23K 20/105

(57) ABSTRACT

An improvement in the composition of an animal feed product prepared from brewery slurry, spent brewer's grain and a liquid GRAS-approved polymer is described. A process for making the animal feed product, wherein the process combines the brewery slurry and spent brewer's grain, and then injects the GRAS-approved polymer into the mixture as the mixture is pumped into a screw press, and then the finished product is collected from the screw press is described.

### CROSS-REFERENCE TO PRIOR APPLICATIONS

The present application claims priority to previously filed U.S. Patent Application 63/354,131, filed 12 Jun. 2022, currently pending, which is incorporated by reference in its entirety.

### STATEMENT REGARDING FEDERALLY SPONSORED RESEARCH OR DEVELOPMENT

The present development was made without federal support.

### NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not applicable.

### STATEMENT REGARDING PRIOR DISCLOSURES BY AN INVENTOR OR JOINT INVENTOR

Not applicable.

### FIELD OF THE INVENTION

The invention relates to the field of compositions for feed products for livestock. In particular, the present invention relates to an improved feed mixture comprising a yeast slurry and spent brewer's grain, and to a process to produce the feed mixture.

### BACKGROUND OF THE INVENTION

The beer brewing process generates organic residual materials, such as brewer's residual yeast, brewer's spent grain, hot trub, runnings from the lauter, and spent grain press liquor. Spent grain or thick stillage is also generated from the bourbon and whiskey distilling processes. The residual yeast and spent grain from these processes generally include protein, a variety of minerals, a relatively high fat content, and relatively low fiber content. Some of these residuals may be recyclable to the process, but much of the residuals requires disposal.

Many municipalities limit the amount of residuals that a producer may send to wastewater treatment facilities or impose substantial surcharges on producers for disposal of these materials. Because of the volume of residuals produced and limited options for converting the residuals to higher value products, the disposal of these byproducts can be expensive for the producers.

In recent years, attempts have been made to convert the brewing residuals to human food products, dough and bread products, cat litter, soil conditioners and fertilizers, pelletized fuel, and animal feed products. However, relatively little progress has been made to find an efficient and economical process to utilize the brewery residuals.

### SUMMARY OF THE PRESENT INVENTION

The present development is an improvement in the composition of an animal feed product made from brewery slurry and spent brewer's grain, wherein the composition further includes a liquid GRAS-approved polymer. The present development is also a process for making the animal feed product, wherein the process involves mixing the brewery slurry with spent brewer's grain, and then injecting the GRAS-approved polymer into the mixture as the mixture is pumped into a screw press, and then collecting the finished product from the screw press. The resulting product is a grain meal product that can easily be transported in bulk packaged and transported. An additional advantage of the present process is that a secondary stream of liquid can be fed from the processing equipment back into the drains with biochemical oxygen demand (BOD) levels and solid levels within acceptable ranges for most municipal treatment facilities.

### BRIEF DESCRIPTION OF THE FIGURES

FIG. 1 is a schematic of the process to produce the composition of the present invention;

FIG. 2 is a schematic of an exemplary apparatus to perform the process of FIG. 1; and,

FIG. 3 is a schematic of a first alternative embodiment of exemplary apparatus to perform the process of FIG. 1.

### DETAILED DESCRIPTION OF THE PRESENT DEVELOPMENT

The present development is an improvement in the composition of an animal feed product that results in a feed product having physical characteristics that allow the product to be easily transported from a brewery to a farm. The feed product of the present development comprises a brewery slurry, spent brewer's grain, and a liquid GRAS-approved polymer (as used herein, GRAS refers to “generally regarded as safe”). In a preferred embodiment, the GRAS-approved polymer is an anionic polyacrylamide. In a more preferred embodiment, the GRAS-approved polymer is a copolymer of acrylamide and sodium acrylate. In a most preferred embodiment, the GRAS-approved polymer is Flopam® AN 934. The resulting product preferably has from about 65 wt % to about 75 wt % moisture with from about 25 wt % to about 35 wt % dry matter. Further, the resulting product preferably has greater than about 30% crude protein. The product of the present invention is a grain meal with physical characteristics that make it acceptable for feed consumption and has a longer shelf life than traditional spent brewer's grain products.

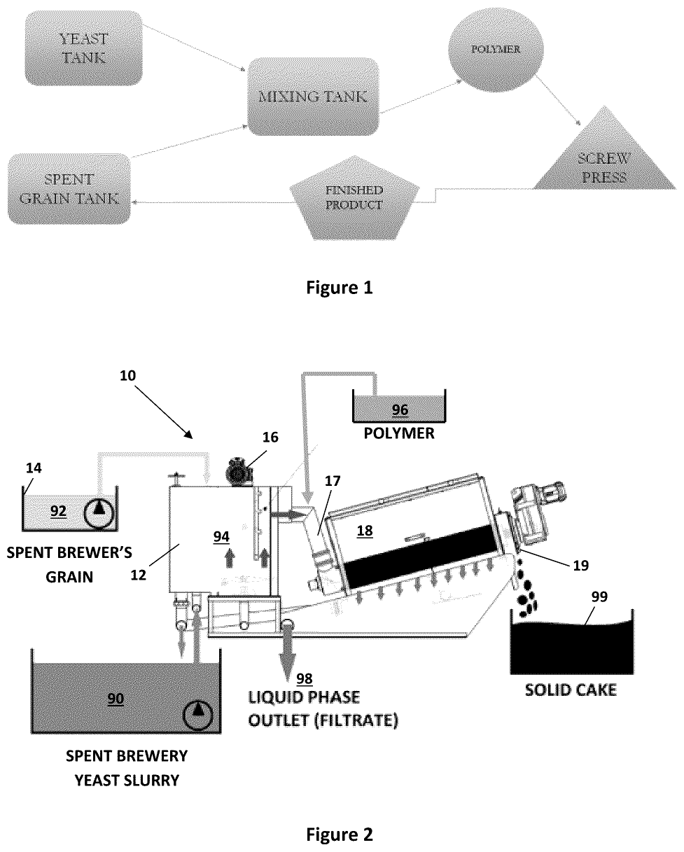

The present development is also a process for making the animal feed product. As shown in FIG. 1, the process involves combining a brewery slurry with spent brewer's grain in a mix tank to form a yeast-grain mixture, then combining the yeast-grain mixture with a GRAS-approved polymer, and then passing the yeast-grain mixture+polymer material through a screw press, and then collecting the animal feed product after processing through the screw press. The resulting product is a feed that can easily be transported.

In an exemplary embodiment, the process involves: (a) adding brewery slurry to a holding/mixing tank; (b) adding spent brewer's grain slurry to the tank; (c) mixing the brewery slurry with the spent brewer's grain slurry with an overhead mixer until the components are blended; (d) pumping the yeast-grain slurry into a screw press while simultaneously injecting the GRAS-approved polymer into the yeast-grain slurry; and, (e) collecting the finished product from the screw press. The resulting product is a grain meal product that can easily be loaded into shipping tanks or packaged and transported or stored in holding or holding/mixing tanks. Optionally, to minimize expenses, the finished product may be fed directly from the screw press back into the feeder tank that originally held the spent grain.

In a preferred embodiment, the brewery slurry is added to the holding/mixing tank such that the volume is equal to or less than about 80% capacity of the tank. This fill level is not critical but provides adequate space for addition of the spent brewer's grain and allows for adequate mixing. Optionally, the spent brewer's grain slurry may be added to the tank before the brewery slurry. However, it has been observed that when this order of addition is used, the brewery slurry settles on the top of the slurry bed and it is more difficult to achieve a well-blended yeast-grain slurry.

Holding tanks or holding/mixing tanks are generally known in the art. The terms “holding tanks” and “holding/mixing tanks” may be used interchangeably herein. In a preferred embodiment, the holding tank is made of steel or stainless steel and is designed to hold a product having a temperature of up to at least 200 degrees Fahrenheit for a sustained period of time, such as for at least two hours. Because the brewery slurry and the spent brewer's grain slurry are mixed in the holding tank, it is recommended that the holding tank include baffles to facilitate property agitation. The number and positioning of the baffles within the holding tank can vary depending on the dimensions of the holding tank, the size and capabilities of the mixer used, the types of materials to be mixed, and the degree of mixing to be achieved. An exemplary holding tank for the current process will have a capacity of from about 4,000 gallons to about 30,000 gallons. In a more preferred embodiment, the holding tank will have a conical bottom.

A variety of mixers may be used to blend slurries. In the present invention, an overhead mixer is recommended, but not required, to achieve adequate mixing. In a preferred embodiment, the holding tank and mixing apparatus are sized to allow for complete blending of the brewery slurry with the spent brewer's grain slurry in less than about 1 hour.

Screw presses are known in the art. In the present invention, it is recommended that the rate of the yeast-grain slurry flow into the screw press be established and that the GRAS polymer be added at the entry point at a rate to deliver the desired amount of polymer into the slurry mixture. In an exemplary application, the rate of the yeast-grain slurry flow into the screw press may be from about 1 gram per minute to about 475 grams per minute, and the rate of polymer delivery may be from about 0.05 ml per litre to about 2 ml per liter. In a preferred embodiment, the rate of polymer addition adjusts as necessary relative to the rate of yeast-grain slurry flow. In a more preferred embodiment, the application rate for the GRAS-approved polymer is up to 5,000 PPM and the polymer can be added at any point prior to entering the screw press.

The brewery slurry can be any liquid byproduct recovered from the alcoholic or non-alcoholic beverage production process that contains less than 2 wt % grain or grain by-product, such as spent yeast slurry, trub, stillage, runnings from the lauter, spent grain press liquor, or a combination thereof. An exemplary brewery slurry is a spent brewery yeast slurry having between about 80 wt % water and about 98 wt % water, and from about 2 wt % dry matter and 20 wt % dry matter. The spent brewer's grain slurry can be any spent grain slurry recovered from the brewing process or from a distilling process or from any waste stream that does not have other chemicals present. An exemplary spent brewery grain slurry has between about 70 wt % water and about 90 wt % water, and from about 10 wt % dry matter and 30 wt % dry matter.

The volume ratio of the brewery slurry to spent brewer's grain slurry used in the yeast-grain slurry can vary from 99% yeast slurry/1% spent grain slurry to 1% yeast slurry/99% spent grain slurry. In a first exemplary embodiment, the volume ratio of the brewery slurry to spent brewer's grain is about 50:50. In a second exemplary embodiment, the volume ratio of the brewery slurry to spent brewer's grain is about 70:30. In a third exemplary embodiment, the volume ratio of the brewery slurry to spent brewer's grain is about 80:20.

The GRAS-approved polymer can be any anionic flocculant and/or non-ionic flocculant that is generally regarded as safe for ingestion. In a preferred embodiment, the GRAS-approved polymer is an anionic polyacrylamide. In a more preferred embodiment, the GRAS-approved polymer is a copolymer of acrylamide and sodium acrylate. In a most preferred embodiment, the GRAS-approved polymer is Flopam® AN 934. Alternatively, the GRAS-approved polymer is a non-ionic polyethylene oxide solubility polymer. Without being bound by theory, it is believed that the GRAS-approved polymer extracts moisture from the yeast-grain slurry as the yeast-grain slurry is fed through the screw press, thereby improving the physical characteristics of the finished product relative to compositions that do not comprise a polymer and relative to compositions that are not processed using a screw press.

The resulting product preferably has from about 65 wt % to about 75 wt % moisture with from about 25 wt % to about 35 wt % dry matter. In a preferred embodiment, the resulting product includes greater than about 20% crude protein.

The process of the present invention may be performed using commercially available equipment, such as the press screw mixing apparatus 10 shown in FIG. 2. The brewery slurry 90 is pumped to a mix tank 12. The spent brewer's grain 92 is pumped from a silo 14 to the mix tank 12. The overhead mixer 16 blends the brewery slurry and the spent brewer's grain to form the yeast-grain slurry 94. The yeast-grain slurry 94 is fed into the screw press 18 from an entry port 17. The GRAS-approved polymer 96 is fed into the screw press 18 at the entry point 17. As the yeast-grain slurry 94 and polymer 96 are carried from the entry point 17 to an exit port 19, the polymer is intimately mixed with the yeast-grain slurry and the mixture is dewatered, producing a filtrate or liquid phase 98 and a filter cake or solid phase 99. The filtrate drains from the screw press 18. The filter cake 99 is the animal feed product of the present application and is collected from the screw press 18. Optionally, the filter cake 99 may be squeezed after processing through the screw press 18 to further reduce the water content of the filter cake 99.

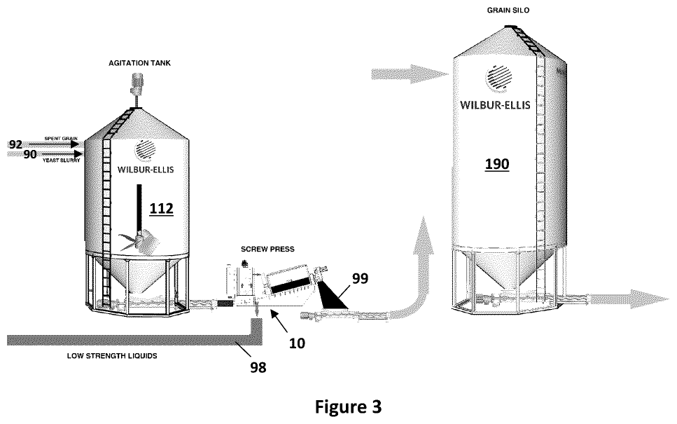

Alternatively, as shown in FIG. 3, the brewery slurry 90 and the spent brewer's grain 92 can initially be pumped into an agitation tank 112 where the brewery slurry 90 and spent brewer's grain 92 is blended before it is pumped to the press screw mixing apparatus 10. The brewery slurry+grain blend enters the mix tank 12 where it is additionally mixed to form the yeast-grain slurry 94. The yeast-grain slurry 94 is fed into the screw press 18 from an entry port 17. The GRAS-approved polymer 96 is fed into the screw press 18 at the entry point 17. As the yeast-grain slurry 94 and polymer 96 are carried from the entry point 17 to an exit port 19, the polymer is intimately mixed with the yeast-grain slurry and the mixture is dewatered, producing a filtrate or liquid phase 98 and a filter cake or solid phase 99. The filtrate drains from the screw press 18. The filter cake 99 is the animal feed product of the present application and is collected from the screw press 18 and fed into a grain silo 190. Optionally, the filter cake 99 may be squeezed after processing through the screw press 18 to further reduce the water content of the filter cake 99.

Although described herein as a composition for animal feed and a method for preparing the composition for animal feed, it is anticipated that the composition may be used for human edible products, or for fertilizer products, or for other products that may be produced from brewery slurry and spent brewer's grain. To prepare products other than animal feed, it is anticipated that GRAS-approved polymers other than those described herein may be used. It is also anticipated that the method as described herein may be used with a variety of GRAS-approved polymers and with a range of yeast to grain ratios without exceeding the scope of the present invention.

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. The term “ambient temperature” as used herein refers to an environmental temperature of from about 0° F. to about 120° F., inclusive.

Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed application.

All compositional percentages used herein are presented on a “by weight” basis, unless designated otherwise.

It is understood that, in light of a reading of the foregoing description, those with ordinary skill in the art will be able to make changes and modifications to the present invention without departing from the spirit or scope of the invention, as defined herein. For example, those skilled in the art may substitute materials supplied by different manufacturers than specified herein without altering the scope of the present invention.

What is claimed is:

1. A method for preparing an animal feed composition, wherein the method comprises:
a. adding brewery slurry and spent brewer's grain slurry to a holding tank;
b. mixing the brewery slurry with the spent brewer's grain slurry until the components are blended and a yeast-grain slurry forms;
c. pumping the yeast-grain slurry into a screw press while simultaneously injecting a generally regarded as safe (“GRAS”)-approved polymer into the yeast-grain slurry; and,
d. collecting the finished product from the screw press.

2. The method of claim 1 wherein the brewery slurry is a liquid byproduct recovered from the alcoholic or non-alcoholic beverage production process that contains less than 2 wt % grain or grain by-product.

3. The method of claim 2 wherein the brewery slurry is selected from spent yeast slurry, trub, stillage, runnings from the lauter, spent grain press liquor, or a combination thereof.

4. The method of claim 1 wherein the brewery slurry is added to the holding tank before the spent brewer's grain slurry.

5. The method of claim 1 wherein the brewery slurry with the spent brewer's grain slurry is mixed with an overhead mixer.

6. The method of claim 1 wherein the brewery slurry comprises between about 2 wt % dry matter and 20 wt % dry matter.

7. The method of claim 1 wherein the spent brewery grain slurry comprises between about 10 wt % dry matter and 30 wt % dry matter.

8. The method of claim 1 wherein the volume ratio of the spent brewery yeast slurry to spent brewer's grain slurry used in the yeast-grain slurry is between 99% yeast slurry/1% spent grain slurry and 1% yeast slurry/99% spent grain slurry.

9. The method of claim 8 wherein the volume ratio of the spent brewery yeast slurry to spent brewer's grain is from about 50:50 to about 80:20.

10. The method of claim 1 wherein the GRAS-approved polymer is an anionic flocculant.

11. The method of claim 10 wherein the GRAS-approved polymer is an anionic polyacrylamide.

12. The method of claim 11 wherein the GRAS-approved polymer is a copolymer of acrylamide and sodium acrylate.

13. The method of claim 1 wherein the GRAS-approved polymer is a non-ionic polyethylene oxide solubility polymer.

14. The method of claim 1 wherein the finished product comprises from about 65 wt % to about 75 wt % moisture with from about 25 wt % to about 35 wt % dry matter.

15. The method of claim 1 wherein the finished product comprises greater than about 30% crude protein.

16. An animal feed composition comprising brewery slurry, spent brewer's grain slurry, and a generally regarded as safe (“GRAS”)-approved polymer, wherein the brewery slurry and spent brewer's grain slurry are mixed to form a yeast-grain slurry, and then the GRAS-approved polymer is injected into a screw press while simultaneously with the yeast-grain slurry, and then the animal feed composition is collected from the screw press.

17. The animal feed composition of claim 16 wherein the GRAS-approved polymer is an anionic flocculant.

18. The animal feed composition of claim 16 wherein the GRAS-approved polymer is a non-ionic polyethylene oxide solubility polymer.

19. The animal feed composition of claim 16 wherein the animal feed comprises from about 65 wt % to about 75 wt % moisture with from about 25 wt % to about 35 wt % dry matter.
